(19) United States
(12) Patent Application Publication
(10) Pub. No.: US 2022/0063680 A1
(43) Pub. Date: Mar. 3, 2022

(54) DELIVERY SYSTEM, DELIVERY METHOD, AND PROGRAM

(71) Applicant: Toyota Jidosha Kabushiki Kaisha, Toyota-shi Aichi-ken (JP)

(72) Inventors: Kunihiro Iwamoto, Nagakute-shi (JP); Hirotaka Komura, Anjo-shi (JP); Yuta Itozawa, Nagoya-shi (JP)

(73) Assignee: Toyota Jidosha Kabushiki Kaisha, Toyota-shi Aichi-ken (JP)

(21) Appl. No.: 17/412,815

(22) Filed: Aug. 26, 2021

(30) Foreign Application Priority Data
Aug. 28, 2020 (JP) 2020-144184

(51) Int. Cl. B60W 60/00; B60W 40/076; B60W 40/105; B60W 10/22; G06K 9/00; G06Q 10/08

(52) U.S. Cl. CPC B60W 60/00256; B60W 60/0016; B60W 40/076; B60W 40/105; B60W 2710/22; G06K 9/00805; G06Q 10/0832; B60W 2552/15; B60W 10/22

(57) ABSTRACT

A delivery system includes an autonomously-moving-type delivery vehicle configured to deliver an article, and a transportation vehicle configured to carry and transport the delivery vehicle, in which the delivery system is configured so that after the transportation vehicle carrying the delivery vehicle travels toward a delivery destination of the article, the delivery vehicle gets out of the transportation vehicle and delivers the article to the delivery destination. The delivery system makes a computer perform processes including determining whether or not the delivery vehicle can get out of the traveling transportation vehicle based on a situation of the transportation vehicle, and making the delivery vehicle get out of the transportation vehicle only when it is determined that the delivery vehicle can get out of the transportation vehicle.

### CROSS REFERENCE TO RELATED APPLICATIONS

This application is based upon and claims the benefit of priority from Japanese patent application No. 2020-144184, filed on Aug. 28, 2020, the disclosure of which is incorporated herein in its entirety by reference.

### BACKGROUND

The present disclosure relates to a delivery system, a delivery method, and a program.

Japanese Unexamined Patent Application Publication No. 2019-69853 discloses a delivery system in which a transportation vehicle that carries therein a delivery vehicle for delivering an article(s) travels to the vicinity of the destination of the article(s) to be delivered (hereinafter also referred to as “delivery destination” of the article(s)), and then the delivery vehicle gets out of the transportation vehicle and delivers the article to the delivery destination.

### SUMMARY

The inventors have found the following problem in the delivery system disclosed in Japanese Unexamined Patent Application Publication No. 2019-69853.

In the delivery system disclosed in Japanese Unexamined Patent Application Publication No. 2019-69853, after the transportation vehicle carrying the delivery vehicle stops, the delivery vehicle gets out of the transportation vehicle. However, if the delivery vehicle can get out of the transportation vehicle before the transportation vehicle stops (i.e., while the transportation vehicle is still traveling), the delivery time can be reduced and therefore the delivery efficiency can be improved. That is, in the delivery system disclosed in Japanese Unexamined Patent Application Publication No. 2019-69853, there is a problem that the delivery efficiency is unsatisfactory.

However, if the delivery vehicle attempts to get out of the transportation vehicle while the transportation vehicle is still traveling, there is a possibility that the delivery vehicle cannot get out of the transportation vehicle.

The present disclosure has been made in view of the above-described circumstances, and an object thereof is to provide a delivery system in which a delivery vehicle can get out of a transportation vehicle carrying that delivery vehicle while the transportation vehicle is still traveling, and hence which has improved delivery efficiency.

A first exemplary aspect is a delivery system including:

an autonomously-moving-type delivery vehicle configured to deliver an article; and

a transportation vehicle configured to carry and transport the delivery vehicle, in which

the delivery system is configured so that after the transportation vehicle carrying the delivery vehicle travels toward a delivery destination of the article, the delivery vehicle gets out of the transportation vehicle and delivers the article to the delivery destination, and

the delivery system makes a computer perform processes including:

determining whether or not the delivery vehicle can get out of the traveling transportation vehicle based on a situation of the transportation vehicle; and

making the delivery vehicle get out of the transportation vehicle only when it is determined that the delivery vehicle can get out of the transportation vehicle.

Further, another exemplary aspect is a delivery method, in which after a transportation vehicle carrying an autonomously-moving-type delivery vehicle travels toward a delivery destination of an article, the delivery vehicle gets out of the transportation vehicle and delivers the article to the delivery destination, the delivery vehicle being configured to deliver the article, and

the delivery method makes a computer perform processes including:

determining whether or not the delivery vehicle can get out of the traveling transportation vehicle based on a situation of the transportation vehicle; and

making the delivery vehicle get out of the transportation vehicle only when it is determined that the delivery vehicle can get out of the transportation vehicle.

Further, another exemplary aspect is a program for making, after a transportation vehicle carrying an autonomously-moving-type delivery vehicle travels toward a delivery destination of an article, the delivery vehicle get out of the transportation vehicle and deliver the article to the delivery destination, the delivery vehicle being configured to deliver the article, in which

the program is adapted to cause a computer to perform processes including:

determining whether or not the delivery vehicle can get out of the traveling transportation vehicle based on a situation of the transportation vehicle; and

making the delivery vehicle get out of the transportation vehicle only when it is determined that the delivery vehicle can get out of the transportation vehicle.

As described above, according to an aspect of the present disclosure, it is determined whether or not the delivery vehicle can get out of the traveling transportation vehicle based on the situation of the transportation vehicle, and the delivery vehicle is made (or allowed) to get out of the transportation vehicle only when it is determined that the delivery vehicle can get out of the transportation vehicle. Therefore, the delivery vehicle can get out of the transportation vehicle while the transportation vehicle is still traveling, so that the delivery system has improved delivery efficiency.

The situation of the transportation vehicle may include at least one of: an obstacle at a time when the delivery vehicle is made to get out of the transportation vehicle; a vibration of the transportation vehicle; a speed of the transportation vehicle; and a gradient of a road on which the transportation vehicle is traveling.

When the delivery vehicle is made to get out of the transportation vehicle, a strength of a suspension of the delivery vehicle may be changed according to a vibration of the transportation vehicle or the delivery vehicle. By the above-described configuration, for example, it is possible to suppress the vibrations of the delivery vehicle caused by irregularities on the road surface.

When the delivery vehicle is made to get out of the transportation vehicle, the delivery vehicle may travel on a slope extending from the transportation vehicle to a ground surface. By the above-described configuration, it is possible to simplify the mechanism for enabling the delivery vehicle to get out of the transportation vehicle.

When the delivery vehicle is made to get out of the transportation vehicle, the delivery vehicle may be conveyed by a conveyor extending from the transportation vehicle to a ground surface. By the above-described configuration, it is possible to reduce the impacts that the wheels of the delivery vehicle receive when the delivery vehicle gets down onto the ground surface.

When the delivery vehicle is made to get out of the transportation vehicle, the delivery vehicle may be conveyed by a crane or a manipulator provided in the transportation vehicle. By the above-described configuration, it is possible to further reduce the impacts that the wheels of the delivery vehicle receive when the delivery vehicle gets down onto the ground surface.

According to the present disclosure, it is possible to provide a delivery system in which a delivery vehicle can get out of a transportation vehicle carrying that delivery vehicle while the transportation vehicle is still traveling, and hence which has improved delivery efficiency.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram of a delivery system according to a first embodiment;

FIG. 2 is a perspective view showing a state in which a delivery vehicle 200 gets of a transportation vehicle 100 in a delivery system according to a first embodiment;

FIG. 3 is a side view showing the state in which the delivery vehicle 200 gets of the transportation vehicle 100 in the delivery system according to the first embodiment;

FIG. 4 is a side view showing a state in which a delivery vehicle 200 gets of a transportation vehicle 100 in a delivery system according to a modified example of the first embodiment;

FIG. 5 is a perspective view showing a state in which a delivery vehicle 200 gets of a transportation vehicle 100 in a delivery system according to a second embodiment; and

FIG. 6 is a side view showing a state in which a delivery vehicle 200 gets of a transportation vehicle 100 in a delivery system according to a third embodiment.

### DESCRIPTION OF EMBODIMENTS

Specific embodiments will be described hereinafter in detail with reference to the drawings. The same or corresponding elements are denoted by the same reference numerals (or symbols) throughout the drawings, and redundant descriptions thereof are omitted as required for clarifying the explanation.

### First Embodiment

### <Configuration of Delivery System>

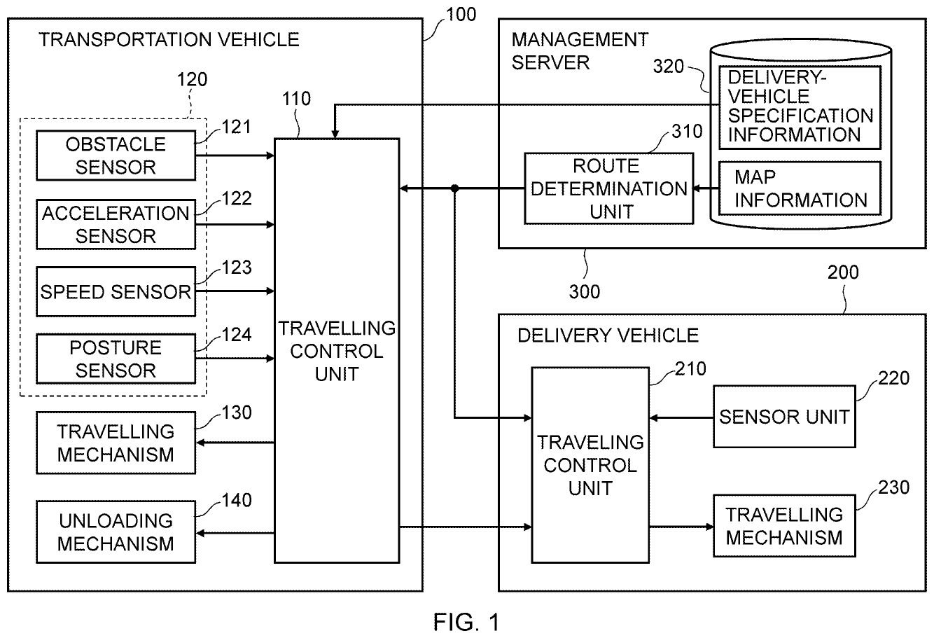

Firstly, a delivery system and a delivery method according to a first embodiment will be described with reference to FIG. 1. FIG. 1 is a block diagram of a delivery system according to the first embodiment. As shown in FIG. 1, the delivery system according to this embodiment includes a transportation vehicle 100, a delivery vehicle 200, and a management server 300.

In the delivery system according to this embodiment, after the transportation vehicle 100 carrying the delivery vehicle 200 travels toward the delivery destination of an article(s), the delivery vehicle 200 gets out of the transportation vehicle 100 and delivers the article(s) to the delivery destination. In particular, in the delivery system according to this embodiment, it is determined whether or not the delivery vehicle 200 can get out of the traveling transportation vehicle 100 based on the situation of the transportation vehicle 100, and only when it is determined that the delivery vehicle 200 can get out of the transportation vehicle 100, the transportation vehicle 100 makes the delivery vehicle 200 gets out of the transportation vehicle 100 (or allows the delivery vehicle 200 to get out of the transportation vehicle 100). The above-described series of processes are performed by a computer.

Note that, as a matter of course, in the delivery system according to the first embodiment, it is assumed that the transportation vehicle 100 and the delivery vehicle 200 travel while complying with traffic laws and the like.

Firstly, the transportation vehicle 100 will be described.

The transportation vehicle 100 carries and transports the delivery vehicle 200. Although the transportation vehicle 100 in this embodiment is an autonomous mobile vehicle (i.e., an autonomously-driven vehicle), the transportation vehicle 100 may be a vehicle driven by a human driver. As shown in FIG. 1, the transportation vehicle 100 includes a traveling control unit 110, a sensor unit 120, a traveling mechanism 130, and an unloading mechanism 140. Further, the transportation vehicle 100 is wirelessly connected to the delivery vehicle 200 and the management server 300 so as to be able to communicable with them.

Note that when the management server 300 is disposed in the transportation vehicle 100, the transportation vehicle 100 may be connected to the management server 300 through a cable(s). Further, although the transportation vehicle 100 includes only one delivery vehicle 200 in the example shown in FIG. 1, the transportation vehicle 100 may include a plurality of delivery vehicles 200.

The traveling control unit 110 controls the traveling mechanism 130 based on various types of information acquired from the sensor unit 120. In this way, the transportation vehicle 100 autonomously travels.

Further, one of the features of the delivery system according to this embodiment is in that the traveling control unit 110 controls the unloading mechanism 140 for enabling the delivery vehicle 200 to get out of the transportation vehicle 100 based on various types of information (i.e., based on the situation of the transportation vehicle 100) acquired from the sensor unit 120.

More specifically, while the transportation vehicle 100 is traveling, the traveling control unit 110 determines whether or not the delivery vehicle 200 can get out of the transportation vehicle 100 based on the situation of the transportation vehicle 100 at or near the getting-off position (or the unloading position) of the delivery vehicle 200. Then, only when the traveling control unit 110 has determined that the delivery vehicle 200 can get out of the transportation vehicle 100, the traveling control unit 110 controls the unloading mechanism 140 so that the delivery vehicle 200 gets out of the transportation vehicle 100, and instructs the delivery vehicle 200 to get out of the transportation vehicle 100.

Note that when the delivery vehicle 200 cannot get out of the transportation vehicle 100 at or near the getting-off position of the delivery vehicle 200 while the transportation vehicle 100 is traveling, the delivery vehicle 200 may get out of the transportation vehicle 100 after the transportation vehicle 100 stops.

The traveling control unit 110 includes, for example, an arithmetic unit such as a CPU (Central Processing Unit), and a storage unit such as a RAM (Random Access Memory) and a ROM (Read Only Memory) in which various types of control programs, data, and the like are stored. That is, the traveling control unit 110 has a function as a computer, and controls the traveling mechanism 130 and the unloading mechanism 140 based on the aforementioned various types of control programs and the like.

In the example shown in FIG. 1, the sensor unit 120 includes an obstacle sensor 121, an acceleration sensor 122, a speed sensor 123, and a posture sensor 124.

The obstacle sensor 121 detects an obstacle ahead of the transportation vehicle 100 in the traveling direction thereof. Further, the obstacle sensor 121 detects an obstacle at the time when the delivery vehicle 200 gets out of the transportation vehicle 100. The obstacle sensor 121 is, for example, a radar sensor, a sonar sensor, an ultrasonic sensor, a lidar sensor, a camera, or the like. Examples of the obstacle include people such as pedestrians and animals as well as other vehicles and objects on the road that have accidentally fallen from other vehicles.

The acceleration sensor 122 detects the acceleration of the transportation vehicle 100. It is possible to detect vibrations of the transportation vehicle 100 caused by irregularities or the like on the road surface by detecting the acceleration of the transportation vehicle 100.

The speed sensor 123 detects the speed of the transportation vehicle 100. The posture sensor 124 detects the posture of the transportation vehicle 100. It is possible to detect the gradient of the road on which the transportation vehicle 100 is traveling (hereinafter also referred to as the road gradient) by the posture sensor 124.

The traveling mechanism 130 is a mechanism for moving the transportation vehicle 100 (i.e., making the transportation vehicle 100 travel). For example, the traveling mechanism 130 includes, in addition to the driving mechanism, such as a motor or an engine, for moving the transportation vehicle 100, a braking mechanism for stopping the transportation vehicle 100, and a steering mechanism for making the transportation vehicle 100 turn (i.e., making the transportation vehicle 100 change the traveling direction).

The unloading mechanism 140 is a mechanism for making the delivery vehicle 200 get out of the transportation vehicle 100 (or for enabling the delivery vehicle 200 to get out of the transportation vehicle 100, or for unloading the delivery vehicle 200 from the transportation vehicle 100). Details of the unloading mechanism 140 will be described later.

Next, the delivery vehicle 200 will be described.

The delivery vehicle 200 is an autonomous mobile vehicle which, after being transported by the transportation vehicle 100, gets out of the transportation vehicle 100 and delivers an article(s) to the delivery destination thereof. As shown in FIG. 1, the delivery vehicle 200 includes a traveling control unit 210, a sensor unit 220, and a traveling mechanism 230. Further, the delivery vehicle 200 is wireles sly connected to the transportation vehicle 100 and the management server 300 so as to be able to communicable with them. Note that when the management server 300 is disposed in the delivery vehicle 200, the delivery vehicle 200 may be connected to the management server 300 through a cable(s).

The traveling control unit 210 controls the traveling mechanism 230 based on various types of information acquired from the sensor unit 220. That is, the delivery vehicle 200 autonomously travels as the traveling control unit 210 controls the traveling mechanism 230. Note that, similarly to the sensor unit 120 of the transportation vehicle 100, the sensor unit 220 includes various types of sensors.

Similarly to the traveling control unit 110 of the transportation vehicle 100, the traveling control unit 210 includes an arithmetic unit such as a CPU, and a storage unit such as a RAM and a ROM in which various types of control programs, data, and the like are stored. That is, the traveling control unit 210 has a function as a computer, and controls the traveling mechanism 230 based on the aforementioned various types of control programs and the like.

The traveling mechanism 230 is a mechanism for moving the delivery vehicle 200 (i.e., making the delivery vehicle 200 travel). For example, the traveling mechanism 230 includes, in addition to the driving mechanism, such as a motor or an engine, for moving the delivery vehicle 200, a braking mechanism for stopping the delivery vehicle 200, and a steering mechanism for making the delivery vehicle 200 turn (i.e., making the delivery vehicle 200 change the traveling direction).

Next, the management server 300 will be described.

The management server 300 is a server for managing the delivery system, and is, for example, a cloud server. As shown in FIG. 1, the management server 300 includes a route determination unit 310 and a storage unit 320.

The route determination unit 310 determines a delivery route from the place where the transportation vehicle 100 is currently present to a delivery destination based on map information. Then, the route determination unit 310 transmits the determined delivery route to the traveling control unit 110 of the transportation vehicle 100 and the traveling control unit 210 of the delivery vehicle 200. The delivery route also includes the getting-off position (or the unloading position) of the delivery vehicle 200. Note that the getting-off position is set in an area where the delivery vehicle 200 can get out of the traveling transportation vehicle 100 while complying with traffic laws and the like. Further, the map information may include road-surface information.

As shown in FIG. 1, the storage unit 320 stores the map information and information about specifications of the delivery vehicle 200 (hereinafter also referred to as specification information of the delivery vehicle 200, or delivery-vehicle specification information). The traveling control unit 110 of the transportation vehicle 100 acquires the delivery-vehicle specification information from the storage unit 320. The traveling control unit 110 controls the unloading mechanism 140 based on various types of information (i.e., the situation of the transportation vehicle 100) acquired from the sensor unit 120 and the delivery-vehicle specification information.

Note that the place (or the entity) in which the delivery-vehicle specification information stored is not limited to the storage unit 320 of the management server 300, and may be stored anyplace or in any entity. For example, the delivery-vehicle specification information may be stored in advance in a storage unit that is disposed inside the transportation vehicle 100 but is not shown in the drawing (e.g., a storage unit that is disposed inside the traveling control unit 110 but is not sown in the drawing). Alternatively, the delivery-vehicle specification information may be stored in a storage unit that is disposed inside the delivery vehicle 200 but is not shown in the drawing, and the traveling control unit 110 may acquire the delivery-vehicle specification information from the delivery vehicle 200 through the management server 300.

As described above, in the delivery system according to this embodiment, while the transportation vehicle 100 is traveling, the traveling control unit 110 determines whether or not the delivery vehicle 200 can get out of the transportation vehicle 100 based on the situation of the transportation vehicle 100. Then, only when the traveling control unit 110 has determined that the delivery vehicle 200 can get out of the transportation vehicle 100, the traveling control unit 110 controls the unloading mechanism 140 so as to make the delivery vehicle 200 get out of the transportation vehicle 100 (or allow the delivery vehicle 200 to get out of the transportation vehicle 100).

That is, in the delivery system according to this embodiment, only when the traveling control unit 110 determines that the delivery vehicle 200 can get out of the transportation vehicle 100 based on the situation of the transportation vehicle 100, the delivery vehicle 200 gets out of the traveling transportation vehicle 100. Therefore, in the delivery system according to this embodiment, the delivery vehicle 200 can get out of the transportation vehicle 100 while the transportation vehicle 100 is traveling, so that the delivery system has improved delivery efficiency.

Further, in the case where a plurality of delivery vehicles 200 carried in the transportation vehicle 100 deliver articles to delivery destinations different from each other, the delivery efficiency of the delivery system is improved. For example, in the outward route, while the transportation vehicle 100 is traveling, a plurality of delivery vehicles 200 are made to get out of the transportation vehicle 100 one after another at their respective delivery destinations. Then, in the return route, the transportation vehicle 100 collect the delivery vehicles 200, which have already delivered the articles, one after another at the respective delivery destinations. In this way, the delivery efficiency of the delivery system is improved.

### <Unloading Mechanism 140 and Its Control Method>

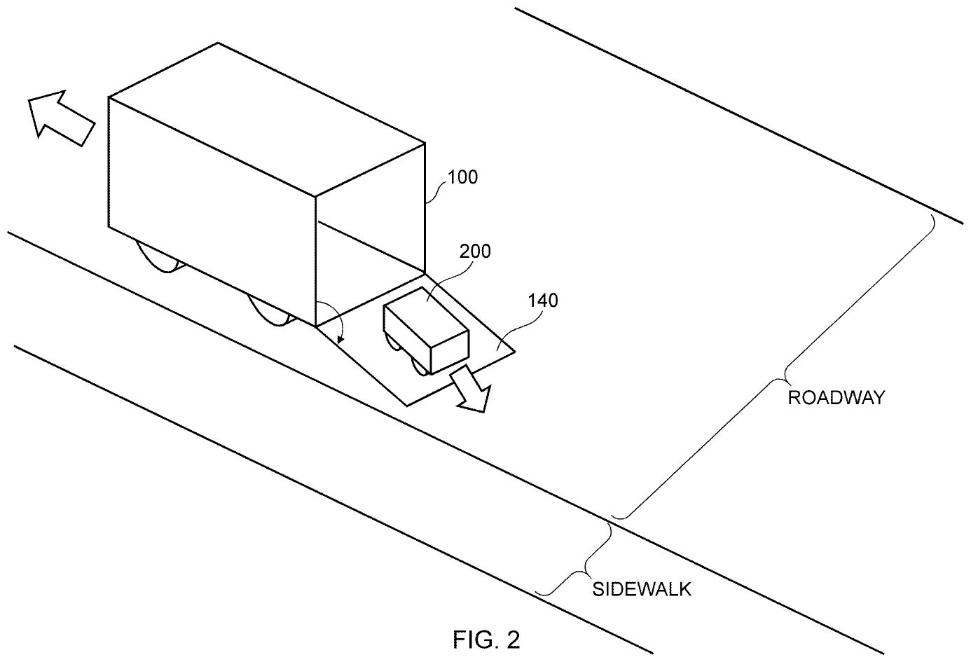

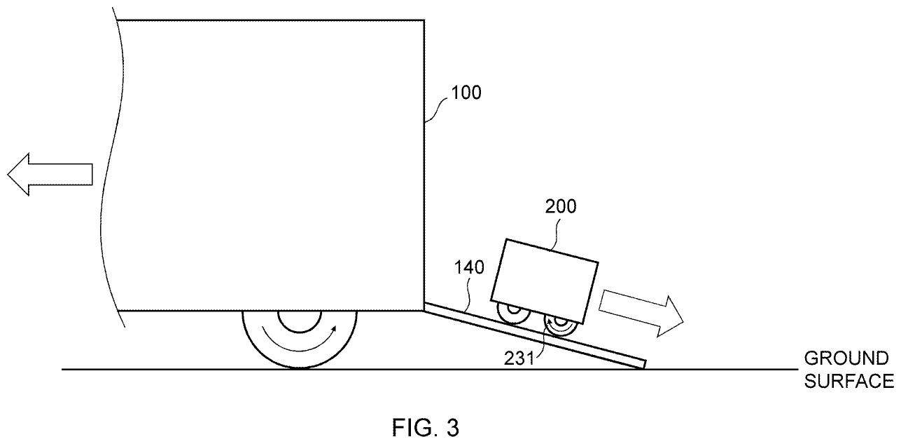

Next, the unloading mechanism 140 and its control method will be described in detail with reference to FIGS. 2 and 3 as well as with reference to FIG. 1. FIG. 2 is a perspective view showing a state in which the delivery vehicle 200 gets out of the transportation vehicle 100. FIG. 3 is a side view showing the state in which the delivery vehicle 200 gets out of the transportation vehicle 100.

As shown in FIGS. 2 and 3, the unloading mechanism 140 according to this embodiment is a simple plate-like slope. In the example shown in FIGS. 2 and 3, the unloading mechanism 140 also functions as an opening/closing door provided in the rear part of the transportation vehicle 100. The unloading mechanism 140 is connected to one side (e.g., a side at the lower edge) of the opening provided in the rear part of the transportation vehicle 100. In the normal state, the unloading mechanism 140 serves as an opening/closing door and is closed. However, when the delivery vehicle 200 gets out of the transportation vehicle 100, the unloading mechanism 140, which serves as the opening/closing door, is opened and functions as a slope extending from the inside of the transportation vehicle 100 to the ground surface.

Note that the unloading mechanism 140 may be provided separately from the opening/closing door provided in the rear part of the transportation vehicle 100 as long as it can function as a slope. In such a case, in the normal state, the unloading mechanism 140 is housed, for example, under the floor of the transportation vehicle 100.

As described above, when the traveling transportation vehicle 100 has traveled close to the getting-off position (or the unloading portion) of the delivery vehicle 200, the traveling control unit 110 determines whether or not the delivery vehicle 200 can get out of the transportation vehicle 100 based on the situation of the transportation vehicle 100. Then, only when the traveling control unit 110 has determined that the delivery vehicle 200 can get out of the transportation vehicle 100, the traveling control unit 110 controls the unloading mechanism 140 so that the delivery vehicle 200 can get out of the transportation vehicle 100. That is, as shown in FIGS. 2 and 3, the traveling control unit 110 opens the unloading mechanism 140, which functions as the opening/closing door, and makes the unloading mechanism 140 function as a slope extending from the inside of the transportation vehicle 100 to the ground surface.

The situation of the transportation vehicle 100, which is the condition under which the above-described determination is made (hereinafter also referred to as the determination condition), includes at least one of a traveling state such as a speed and/or an acceleration of the transportation vehicle 100, and a traveling environment such as an obstacle and/or a road gradient.

For example, when no obstacle is detected in the direction in which the delivery vehicle 200 gets out of by the obstacle sensor 121 shown in FIG. 1, the traveling control unit 110 determines that the delivery vehicle 200 can get out of the transportation vehicle 100.

Further, for example, when the vibrations of the transportation vehicle 100 detected by the acceleration sensor 122 shown in FIG. 1 decreases below a predetermined reference value, the traveling control unit 110 determines that the delivery vehicle 200 can get out of the transportation vehicle 100. The predetermined reference value for the vibrations of the transportation vehicle 100 is determined, for example, based on the delivery-vehicle specification information. For example, when the vibrations of the transportation vehicle 100 exceed the predetermined reference value, the delivery vehicle 200 may not be able to get out of the transportation vehicle 100 because of the specifications of the delivery vehicle 200.

Note that the reference value may also be changed according to the type and/or the weight of the article(s) delivered by the delivery vehicle 200. For example, in the case of a fragile article such as a glass product, a ceramic product, or a precision apparatus, the reference value is set to a value smaller than those for other types of articles.

Note that when the delivery vehicle 200 gets out of the transportation vehicle 100, the traveling control unit 110 may instruct the traveling control unit 210 of the transportation vehicle 100 to change the strength of the suspension of the delivery vehicle 200 according to the vibrations of the transportation vehicle 100. Specifically, when the vibrations of the transportation vehicle 100 are large, the strength of the suspension of the delivery vehicle 200 is increased. By the above-described configuration, it is possible to suppress, for example, the vibrations of the delivery vehicle 200 caused by irregularities on the road surface.

Note that the vibrations of the delivery vehicle 200 may be detected by the sensor unit 220 of the delivery vehicle 200, and the strength of the suspension of the delivery vehicle 200 at the time when the delivery vehicle 200 gets out of the transportation vehicle 100 may be changed according to the detected vibrations of the delivery vehicle 200.

Further, for example, when the speed of the transportation vehicle 100 detected by the speed sensor 123 shown in FIG. 1 decreases below a predetermined reference value, the traveling control unit 110 determines that the delivery vehicle 200 can get out of the transportation vehicle 100. The predetermined reference value for the speed of the transportation vehicle 100 is determined, for example, based on the delivery-vehicle specification information. For example, when the speed of the transportation vehicle 100 exceeds the predetermined reference value, the delivery vehicle 200 may not be able to get out of the transportation vehicle 100 because of the specifications of the delivery vehicle 200. Note that the reference value may also be changed according to the type and/or the weight of the article(s) delivered by the delivery vehicle 200.

Further, for example, when the road gradient detected by the posture sensor 124 shown in FIG. 1 decreases below a predetermined reference value, the traveling control unit 110 determines that the delivery vehicle 200 can get out of the transportation vehicle 100. The predetermined reference value for the road gradient is determined, for example, based on the delivery-vehicle specification information. For example, when the road gradient exceeds the predetermined reference value, the delivery vehicle 200 may not be able to travel (i.e., move) after it gets out of the transportation vehicle 100 because of the specifications of the delivery vehicle 200. Note that the reference value may also be changed according to the type and/or the weight of the article(s) delivered by the delivery vehicle 200.

In the case where it is determined whether or not the delivery vehicle 200 can get out of the transportation vehicle 100 based on a plurality of determination conditions, it is determined that the delivery vehicle 200 can get out of the transportation vehicle 100 when, for example, all the determination conditions are satisfied.

When it is determined that the delivery vehicle 200 can get out of the transportation vehicle 100, the traveling control unit 110 instructs the delivery vehicle 200 to get out of the transportation vehicle 100. Specifically, as shown in FIG. 1, the traveling control unit 110 of the transportation vehicle 100 instructs the traveling control unit 210 of the delivery vehicle 200 to get out of the transportation vehicle 100. Then, as shown in FIG. 2, the delivery vehicle 200 travels on the unloading mechanism 140 and thereby gets down onto the roadway. Further, the delivery vehicle 200 delivers the article(s) to the delivery destination, for example, by traveling from the roadway to the sidewalk and to the delivery destination.

As shown in FIG. 3, when the delivery vehicle 200 travels on the unloading mechanism 140 and gets down on the ground surface, the wheels 231 of the delivery vehicle 200 rotate in the direction indicated by the arrow. Note that since the transportation vehicle 100 is traveling in the direction indicated by the outlined arrow, forces are applied to the wheels 231 in the direction opposite to the rotational direction thereof as the delivery vehicle 200 gets down onto the ground surface (i.e., as the wheels 231 come into contact with the ground surface). Therefore, some or all of the wheels 231 that function as the driving wheels may be disconnected from the driving mechanism when the delivery vehicle 200 gets down onto the ground surface. By the above-described configuration, it is possible to reduce the impacts that the wheels 231 receive as the delivery vehicle 200 gets down onto the ground surface.

### Modified Example of First Embodiment

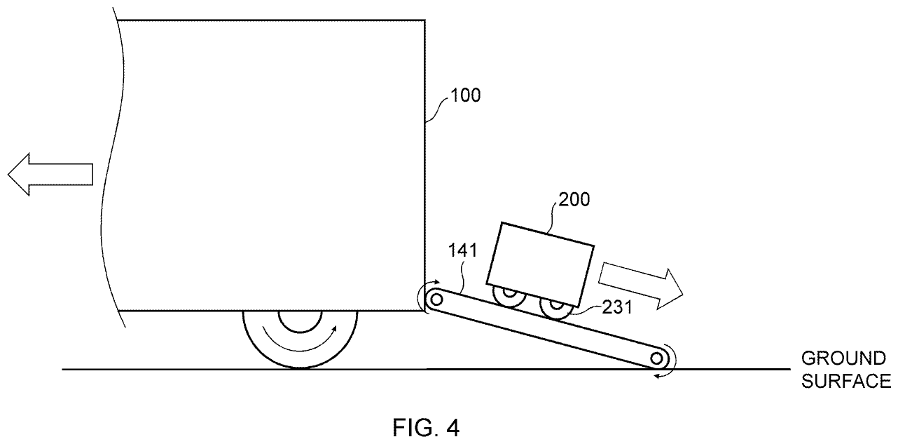

Next, a delivery system according to a modified example of the first embodiment will be described with reference to FIG. 4. FIG. 4 is a side view showing a state in which a delivery vehicle 200 gets out of (i.e., is unloaded from) a transportation vehicle 100 in the delivery system according to the modified example of the first embodiment. FIG. 4 is a drawing corresponding to FIG. 3.

As shown in FIG. 4, in the delivery system according to the modified example of the first embodiment, an unloading mechanism 141 has a function as a belt conveyor in addition to the function of the unloading mechanism 140 shown in FIG. 3.

In the delivery system according to the modified example, as shown in FIG. 4, the delivery vehicle 200 does not travel on the unloading mechanism 141 by itself, but the delivery vehicle 200 is instead conveyed from the inside of the transportation vehicle 100 to the ground surface by the unloading mechanism 141 having the function as a belt conveyor. Therefore, when the delivery vehicle 200 gets down onto the ground surface, the wheels 231 of the delivery vehicle 200 are not rotating. By the above-described configuration, it is possible to further reduce the impacts that the wheels 231 receive as the delivery vehicle 200 gets down onto the ground surface as compared to the first embodiment.

### Second Embodiment

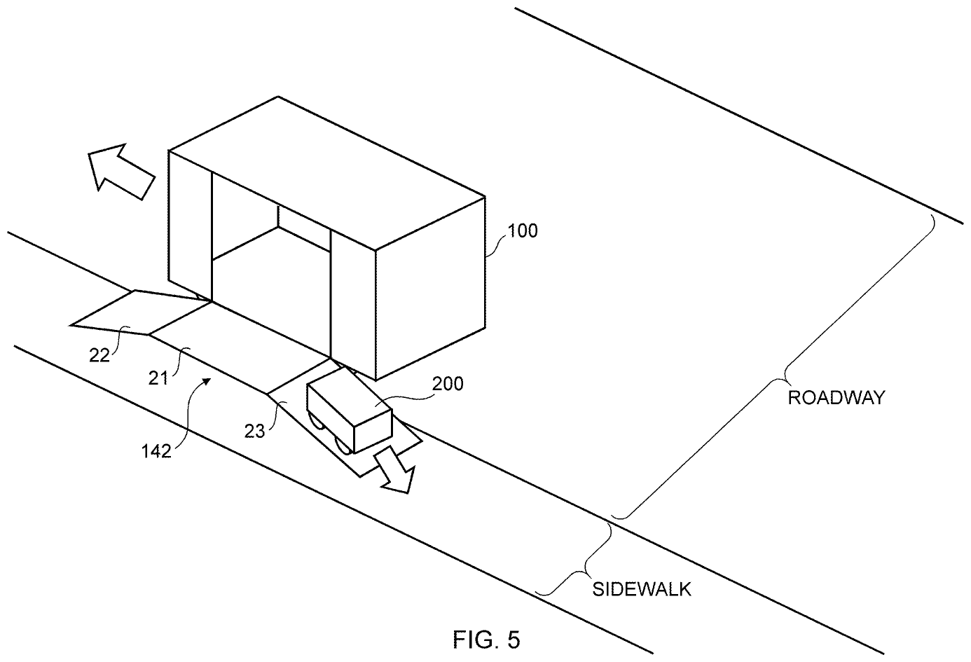

Next, a delivery system and a delivery method according to a second embodiment will be described with reference to FIG. 5. FIG. 5 is a perspective view showing a state in which a delivery vehicle 200 gets out of a transportation vehicle 100 in the delivery system according to the second embodiment. FIG. 5 is a drawing corresponding to FIG. 2.

As shown in FIG. 5, in the delivery system according to the second embodiment, an unloading mechanism 142 is provided on a side of the transportation vehicle 100. Therefore, for example, as shown in FIG. 5, the delivery vehicle 200 can get down directly onto a sidewalk instead of getting down onto a roadway.

In the example shown in FIG. 5, the unloading mechanism 142 includes a horizontal part 21, a front slope part 22, and a rear slope part 23. The delivery vehicle 200 can get out of the transportation vehicle 100 through the horizontal part 21 and the front slope part 22, or though the horizontal part 21 and the rear slope part 23.

The unloading mechanism 142 may be an opening/closing door connected to one side (e.g., a side at the lower edge) of the opening provided on the side of the transportation vehicle 100. When the unloading mechanism 142 is closed, for example, the front slope part 22 and the rear slope part 23 are folded back so that they are placed over the horizontal part 21.

When the delivery vehicle 200 gets out of the front slope part 22 toward the front (i.e., in the traveling direction of the transportation vehicle 100), it is necessary that the speed of the delivery vehicle 200 becomes higher than the speed of the transportation vehicle 100 before the delivery vehicle 200 gets down onto the ground surface. Therefore, for example, when the speed of the transportation vehicle 100 is lower than the maximum speed that the delivery vehicle 200 can reach in the front slope part 22, the traveling control unit 110 determines that the delivery vehicle 200 can get out of the transportation vehicle 100.

In the case where the delivery vehicle 200 gets out of the rear slope part 23 toward the rear (i.e., in the direction opposite to the traveling direction of the transportation vehicle 100), the determination condition is similar to that in the example according to the first embodiment shown in FIG. 3, and therefore the description thereof is omitted.

Further, the rest of the configuration is similar to that of the first embodiment, and therefore the description thereof is omitted.

### Third Embodiment

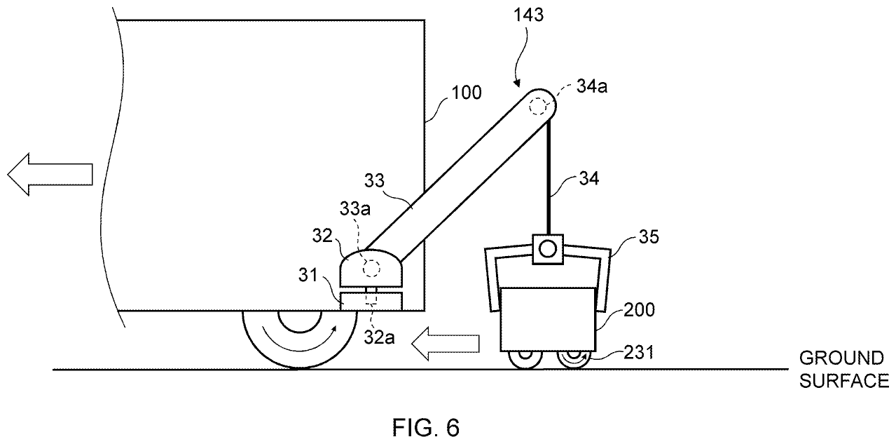

Next, a delivery system and a delivery method according to a third embodiment will be described with reference to FIG. 6. FIG. 6 is a side view showing a state in which a delivery vehicle 200 gets out of (i.e., is unloaded from) a transportation vehicle 100 in the delivery system according to the third embodiment. FIG. 6 is a drawing corresponding to FIG. 3. Although FIG. 6 is a drawing corresponding to FIG. 3, it schematically shows the inside of the transportation vehicle 100, instead of the side thereof.

As shown in FIG. 6, in the delivery system according to the third embodiment, an unloading mechanism 143 is a crane provided in the rear part of the transportation vehicle 100. That is, in the delivery system according to the third embodiment, when the delivery vehicle 200 gets out of (i.e., is unloaded from) the transportation vehicle 100, the delivery vehicle 200 is conveyed by the crane provided in the transportation vehicle 100.

Note that the place where the unloading mechanism 143 is disposed is not limited to any particular places as long as it is disposed inside the transportation vehicle 100. Further, in the example shown in FIG. 6, the unloading mechanism 143 is disposed in the rear part of the transportation vehicle 100, and the delivery vehicle 200 gets out of (i.e., is unloaded from) the transportation vehicle 100 from the rear part thereof.

In the example shown in FIG. 6, the unloading mechanism 143 is a crane including a base part 31, an arm base part 32, an arm 33, a wire 34, and a grasping part 35. The delivery vehicle 200 is grasped and lifted by the grasping part 35, and unloaded from the transportation vehicle 100.

The base part 31 is fixed to the floor surface of the transportation vehicle 100.

The arm base part 32 is connected to the base part 31 through a rotation shaft 32a so that the arm base part 32 can rotate around the rotation shaft 32a. The rotation shaft 32a of the arm base part 32 is a shaft that is positioned perpendicular to the floor surface of the transportation vehicle 100. The arm base part 32 is rotationally driven by a motor or the like (not shown).

The arm 33 is rotatably connected to the arm base part 32 through a joint part 33a provided at the rear end of the arm 33. Note that the rotation axis of the joint part 33a is an axis parallel to the floor surface of the transportation vehicle 100. Since the arm 33 can rotate, the position of the grasping part 35 (i.e., the unloading position of the delivery vehicle 200) can be changed. The arm 33 is rotationally driven by a motor or the like (not shown).

The wire 34 is connected to a winding shaft 34a provided at the tip of the arm 33 in such a manner that the wire 34 can be wound therearound. Note that the rotation axis of the winding shaft 34a is an axis parallel to the rotation axis of the joint part 33a. The grasping part 35 is connected to the tip of the wire 34. The height of the grasping part 35 can be changed by changing the amount of winding of the wire 34. The winding shaft 34a is rotationally driven by a motor or the like (not shown).

By the above-described configuration, it is possible to make the grasping part 35 grasp the delivery vehicle 200 and unload the delivery vehicle 200 from the transportation vehicle 100.

As described above, in the delivery system according to the third embodiment, when the delivery vehicle 200 gets out of (i.e., is unloaded from) the transportation vehicle 100, the delivery vehicle 200 is conveyed by the crane provided in the transportation vehicle 100. Since the wheels 231 of the delivery vehicle 200 are not rotating in the normal state, the impacts that the wheels 231 receive as the delivery vehicle 200 gets down onto the ground can be reduced as compared to those in the first embodiment.

Further, as shown in FIG. 6, the wheels 231 of the delivery vehicle 200 may be rotated in the same direction as the rotation direction of the wheels of the transportation vehicle 100 while the delivery vehicle 200 is being conveyed by the unloading mechanism 143 (i.e., before the delivery vehicle 200 gets down onto the ground surface). In such a case, it is possible reduce the impacts that the wheels 231 receive as the delivery vehicle 200 gets down onto the ground surface even further.

Note that a manipulator (e.g., a robot arm) may be adopted, instead of using the crane, as the unloading mechanism 143. The rest of the configuration is similar to that of the first embodiment, and therefore the description thereof is omitted.

In the above-described examples, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A delivery system comprising:
an autonomously-moving-type delivery vehicle configured to deliver an article; and
a transportation vehicle configured to carry and transport the delivery vehicle, wherein
the delivery system is configured so that after the transportation vehicle carrying the delivery vehicle travels toward a delivery destination of the article, the delivery vehicle gets out of the transportation vehicle and delivers the article to the delivery destination, and
the delivery system makes a computer perform processes including:
determining whether or not the delivery vehicle can get out of the traveling transportation vehicle based on a situation of the transportation vehicle; and
making the delivery vehicle get out of the transportation vehicle only when it is determined that the delivery vehicle can get out of the transportation vehicle.

2. The delivery system according to claim 1, wherein the situation of the transportation vehicle includes at least one of:
an obstacle at a time when the delivery vehicle is made to get out of the transportation vehicle;
a vibration of the transportation vehicle;
a speed of the transportation vehicle; and
a gradient of a road on which the transportation vehicle is traveling.

3. The delivery system according to claim 1, wherein when the delivery vehicle is made to get out of the transportation vehicle, a strength of a suspension of the delivery vehicle is changed according to a vibration of the transportation vehicle or the delivery vehicle.

4. The delivery system according to claim 1, wherein when the delivery vehicle is made to get out of the transportation vehicle, the delivery vehicle travels on a slope extending from the transportation vehicle to a ground surface.

5. The delivery system according to claim 1, wherein when the delivery vehicle is made to get out of the transportation vehicle, the delivery vehicle is conveyed by a conveyor extending from the transportation vehicle to a ground surface.

6. The delivery system according to claim 1, wherein when the delivery vehicle is made to get out of the transportation vehicle, the delivery vehicle may be conveyed by a crane or a manipulator provided in the transportation vehicle.

7. A delivery method, wherein
after a transportation vehicle carrying an autonomously-moving-type delivery vehicle travels toward a delivery destination of an article, the delivery vehicle gets out of the transportation vehicle and delivers the article to the delivery destination, the delivery vehicle being configured to deliver the article, and
the delivery method makes a computer perform processes including:
determining whether or not the delivery vehicle can get out of the traveling transportation vehicle based on a situation of the transportation vehicle; and
making the delivery vehicle get out of the transportation vehicle only when it is determined that the delivery vehicle can get out of the transportation vehicle.

8. The delivery method according to claim 7, wherein the situation of the transportation vehicle includes at least one of:
an obstacle at a time when the delivery vehicle is made to get out of the transportation vehicle;
a vibration of the transportation vehicle;
a speed of the transportation vehicle; and
a gradient of a road on which the transportation vehicle is traveling.

9. The delivery method according to claim 7, wherein when the delivery vehicle is made to get out of the transportation vehicle, a strength of a suspension of the delivery vehicle is changed according to a vibration of the transportation vehicle or the delivery vehicle.

10. The delivery method according to claim 7, wherein when the delivery vehicle is made to get out of the transportation vehicle, the delivery vehicle travels on a slope extending from the transportation vehicle to a ground surface.

11. The delivery method according to claim 7, wherein when the delivery vehicle is made to get out of the transportation vehicle, the delivery vehicle is conveyed by a conveyor extending from the transportation vehicle to a ground surface.

12. The delivery method according to claim 7, wherein when the delivery vehicle is made to get out of the transportation vehicle, the delivery vehicle may be conveyed by a crane or a manipulator provided in the transportation vehicle.

13. A non-transitory computer readable medium storing a program for making, after a transportation vehicle carrying an autonomously-moving-type delivery vehicle travels toward a delivery destination of an article, the delivery vehicle get out of the transportation vehicle and deliver the article to the delivery destination, the delivery vehicle being configured to deliver the article, wherein
the program is adapted to cause a computer to perform processes including:
determining whether or not the delivery vehicle can get out of the traveling transportation vehicle based on a situation of the transportation vehicle; and
making the delivery vehicle get out of the transportation vehicle only when it is determined that the delivery vehicle can get out of the transportation vehicle.
